(19) United States
(12) Patent Application Publication
(10) Pub. No.: US 2023/0098834 A1
(43) Pub. Date: Mar. 30, 2023

(54) TRANSMISSION MECHANISM OF ELECTROMECHANICAL LOCK

(71) Applicant: PRIMAX ELECTRONICS LTD., Taipei City (TW)

(72) Inventor: JUI-JEN CHENG, Taipei City (TW)

(21) Appl. No.: 17/506,701

(22) Filed: Oct. 21, 2021

(30) Foreign Application Priority Data
Sep. 24, 2021 (TW) 110135652

(51) Int. Cl. E05B 47/00

(52) U.S. Cl. CPC E05B 47/0012; E05B 2047/002; E05B 2047/0026; E05B 2047/0017

(57) ABSTRACT

A transmission mechanism of an electromechanical lock includes a first rotating wheel and a rotatable structure. The first rotating wheel has a recessed portion and two first protruding portions. The recessed portion is arranged in a center of the first rotating wheel, and the two first protruding portions are separated from each other and protrude from a side surface of the recessed portion. The rotatable structure is arranged in the recessed portion. The rotatable structure includes a rotatable portion and two elastic members. The rotatable portion is rotatably arranged in the recessed portion. The two elastic members are separated from each other and connected to the rotatable portion, in which each of the elastic members has a second protruding portion close to the side surface of the recessed portion and is configured to interfere with each of the first protruding portions.

### FIELD OF THE INVENTION

The present invention relates to a transmission mechanism of an electromechanical lock.

### BACKGROUND OF THE INVENTION

Generally, an electric lock uses a motor as its power source, and components transmit the torque output by the motor to drive a clutch mechanism of the electric lock to control a door latch to be in a locked position or an unlocked position. However, if there is a power outage, motor failure or component jamming, the electric lock will not be unlocked normally, which may cause personnel to be unable to enter and exit, thereby causing greater danger.

### SUMMARY OF THE INVENTION

The present disclosure provides a transmission mechanism of an electromechanical lock, which includes a first rotating wheel and a rotatable structure. The first rotating wheel has a recessed portion and two first protruding portions. The recessed portion is arranged in a center of the first rotating wheel, and the two first protruding portions are separated from each other and protrude from a side surface of the recessed portion. The rotatable structure is arranged in the recessed portion. The rotatable structure includes a rotatable portion and two elastic members. The rotatable portion is rotatably arranged in the recessed portion. The two elastic members are separated from each other and connected to the rotatable portion, in which each of the elastic members has a second protruding portion close to the side surface of the recessed portion and is configured to interfere with each of the first protruding portions.

In some embodiments of the present invention, the rotatable portion has two grooves corresponding to the two elastic members, respectively, and each of the elastic members further has two connecting portions, and the second protruding portion is connected between the two connecting portions, and one end of each of the connecting portions is arranged in the corresponding groove.

In some embodiments of the present invention, the rotatable portion has a long axis portion and a short axis portion, and the long axis portion is close to the side surface of the recessed portion, and the two grooves are arranged in the short axis portion.

In some embodiments of the present invention, each of the grooves is U-shaped, and the end of each of the connecting portions is L-shaped.

In some embodiments of the present invention, the rotatable portion has an edge groove arranged in an edge of the rotatable portion, and when the first rotating wheel rotates, the two first protruding portions are able to pass through the edge groove.

In some embodiments of the present invention, when the first rotating wheel rotates and one of the two first protruding portions interferes with the second protruding portion, the first rotating wheel drives the rotatable structure to rotate; and when the first rotating wheel rotates and each of the first protruding portions does not interfere with each of the second protruding portions, the rotatable structure does not rotate.

In some embodiments of the present invention, the transmission mechanism further includes a rotating shaft penetrating the rotatable portion and the first rotating wheel.

In some embodiments of the present invention, except for the rotatable portion, the two elastic members and a portion of the rotating shaft are located in the recessed portion, there is no other component located in the recessed portion.

In some embodiments of the present invention, when the first rotating wheel cannot rotate and the rotating shaft is rotated, the rotating shaft drives the rotatable structure to rotate to unlock.

In some embodiments of the present invention, when the rotating shaft is rotated, the second protruding portion is moved from a side of one of the two first protruding portions to another side of the one of the two first protruding portions to unlock.

In some embodiments of the present invention, a portion of the rotating shaft is away from the rotatable portion and protrudes out of the first rotating wheel, and the portion of the rotating shaft has a long axis portion and a short shaft portion, and the transmission mechanism further includes a circuit board close to the portion of the rotating shaft, and the circuit board includes: a substrate; and an unlock switch and a lock switch arranged over the substrate, in which when the rotating shaft is rotated, one end of the long axis portion of the portion of the rotating shaft directly or indirectly presses the unlock switch to unlock, or one end of the long axis portion of the portion of the rotating shaft directly or indirectly presses the lock switch to lock.

In some embodiments of the present invention, the circuit board further includes: a first swing arm corresponding to the unlock switch and arranged between the portion of the rotating shaft and the unlock switch; and a second swing arm corresponding to the lock switch and arranged between the portion of the rotating shaft and the lock switch.

In some embodiments of the present invention, the rotatable portion has a first opening and a second opening through the rotatable portion, and the second opening is substantially aligned with the first opening, and a shape of the first opening is different from a shape of the second opening, and the first rotating wheel has a third opening through the first rotating wheel and adjacent to and substantially aligned with the second opening, and the shape of the second opening is substantially same as a shape of the third opening, and the transmission mechanism further includes a rotating shaft having a first portion and a second portion connected to each other, in which the first portion is arranged in the first opening of the rotatable portion, and the second portion is arranged in the second opening of the rotatable portion and the third opening of the first rotating wheel.

In some embodiments of the present invention, the first opening is non-circular, and the second opening and the third opening are circular.

In some embodiments of the present invention, the rotating shaft further has a third portion connected to the second portion, and the second portion is connected between the first portion and the third portion, and the third portion has a long axis portion and a short axis portion, and the long axis portion of the third portion has two ends, and each of the ends has a convex point or a sharp point.

In some embodiments of the present invention, the transmission mechanism further includes: an electric actuator; a turbine connected to the electric actuator; and a second rotating wheel connected between the turbine and the first rotating wheel, in which the turbine and the second rotating wheel are configured to transmit torque output by the electric actuator to the first rotating wheel.

In some embodiments of the present invention, the transmission mechanism further includes: a third rotating wheel connected between the second rotating wheel and the first rotating wheel, and the turbine, the second rotating wheel and the third rotating wheel are configured to transmit the torque output by the electric actuator to the first rotating wheel.

The transmission mechanism of the electromechanical lock of the present invention has the rotatable structure, which includes the rotatable portion and the two elastic members. The elasticity of the two elastic members can be used to unlock or lock when the lock body fails, reset in case of sudden power failure, or when the locked/unlocked position is incorrect, and thus can effectively solve the technical issues described in the related art. It is worth noting that the transmission mechanism/rotatable structure of the present invention having a small number of components can achieve the purpose of linkage and clutch and take into account safety, so the cost is extremely advantageous. In addition, the assembly of the transmission mechanism/rotatable structure of the present invention is very easy, and the fixing method of the elastic members is simple. On the other hand, there are two elastic members, and the torsion force required for the deformation of the elastic member is moderate, so the service life of each of the elastic members is longer.

### BRIEF DESCRIPTION OF THE DRAWINGS

FIG. 1 is a schematic diagram of components of an electromechanical lock according to an embodiment of the present invention.

FIG. 2 is a schematic diagram of a transmission mechanism of an electromechanical lock according to an embodiment of the present invention.

FIG. 3 is a front schematic view of a rotatable structure according to an embodiment of the present invention.

FIG. 4 is a schematic back view of a rotatable structure according to an embodiment of the present invention.

FIG. 5 is a schematic cross-sectional view of a transmission mechanism according to an embodiment of the present invention.

FIG. 6 is a schematic top view of a transmission mechanism of an electromechanical lock according to an embodiment of the present invention.

FIGS. 7A, 7B, and 7C are schematic top views of a third portion of a rotating shaft according to some embodiments of the present invention.

FIGS. 8A, 8B, 8C, 8D, 8E, 8F and 8G are schematic diagrams of a general mechanism of a transmission mechanism according to an embodiment of the present invention.

FIGS. 9A, 9B, and 9C are schematic diagrams of a safety mechanism of a transmission mechanism according to an embodiment of the present invention.

### DETAIL DESCRIPTION OF THE PREFERRED EMBODIMENT

The advantages and features of the present invention and the method for achieving the same will be described in more detail with reference to exemplary embodiments and the accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180 degrees, the relationship between the one element and the other element may change from “beneath” to “over.” In addition, the spatially relative descriptions used herein should be interpreted the same.

As described in the related art, if there is a power outage, motor failure or component jamming, the electric lock will not be unlocked normally, which may cause personnel to be unable to enter and exit, thereby causing greater danger. Accordingly, the present invention provides a transmission mechanism of an electromechanical lock to solve the above technical issues through a design of a rotatable structure having a rotatable portion and two elastic members. Various embodiments of the transmission mechanism of the electromechanical lock of the present invention will be described in detail below.

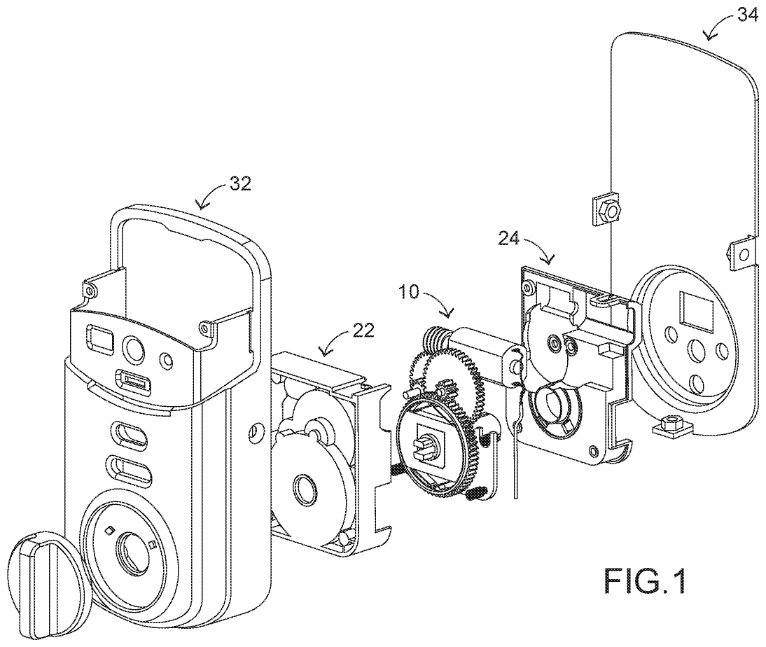

FIG. 1 is a schematic diagram of components of an electromechanical lock according to an embodiment of the present invention. As shown in FIG. 1, the electromechanical lock includes a transmission mechanism 10, a first cover 22, a second cover 24, a first housing 32 and a second housing 34. The transmission mechanism 10, the first cover 22 and the second cover 24 are arranged between the first housing 32 and the second housing 34.

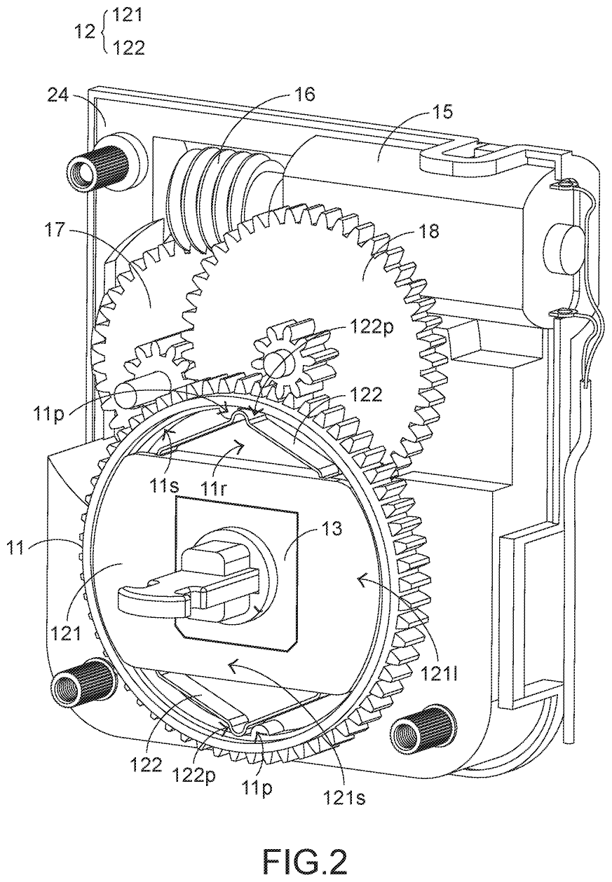

FIG. 2 is a schematic diagram of a transmission mechanism of an electromechanical lock according to an embodiment of the present invention. Please refer to FIGS. 1 and 2, the transmission mechanism 10 includes a first rotating wheel 11 and a rotatable structure 12. The first rotating wheel 11 has a recessed portion 11r and two first protruding portions 11p. The recessed portion 11r is provided in a center of the first rotating wheel 11. The two first protruding portions 11p are separated from each other and protrude from a side surface 11s of the recessed portion 11r, for example, protruding from the side surface 11s of the recessed portion 11r along a radial direction. In some embodiments, the two first protruding portions 11p are separated by 180 degrees from each other, but not limited thereto. The two first protruding portions can be separated by any other angle.

Please continue to refer to FIG. 2, the rotatable structure 12 is arranged in the recessed portion 11r. The rotatable structure 12 includes a rotatable portion 121 and two elastic members 122. The rotatable portion 121 is rotatably arranged in the recessed portion 11r. In some embodiments, the rotatable portion 121 is not in contact with a bottom surface of the recessed portion 11r, but not limited thereto. In some embodiments, from a side view, a top surface of the rotatable portion 121 is substantially coplanar with a top surface of the first rotating wheel 11, so that the rotatable portion 121 does not occupy additional volume. In some embodiments, the rotatable portion 121 has a long axis portion 1211 and a short axis portion 121s. Compared to the short axis portion 121s, the long axis portion 1211 is closer to the side surface 11s of the recessed portion 11r. In some embodiments, the long axis portion 1211 is not in contact with the side surface 11s of the recessed portion 11r, but not limited thereto.

Please continue to refer to FIG. 2, the two elastic members 122 have rigidity and elasticity, so as to achieve the purpose of linkage and clutching and safety. The two elastic members 122 are separated from each other and connected to the rotatable portion 121, in which each of the elastic members 122 has a second protruding portion 122p close to the side surface 11 s of the recessed portion 11r. The second protruding portion 122p is configured to interfere with each of the first protruding portions 11p. In some embodiments, the two second protruding portions 122p are separated by 180 degrees from each other, but not limited thereto. The two second protruding portions can be separated by any other angle. In some embodiments, the second protruding portion 122p can be in contact with the side surface 11s of the recessed portion 11r, but not limited thereto. The size and the material of the first protruding portion 11p and the second protruding portion 122p can be appropriately adjusted according to actual requirements.

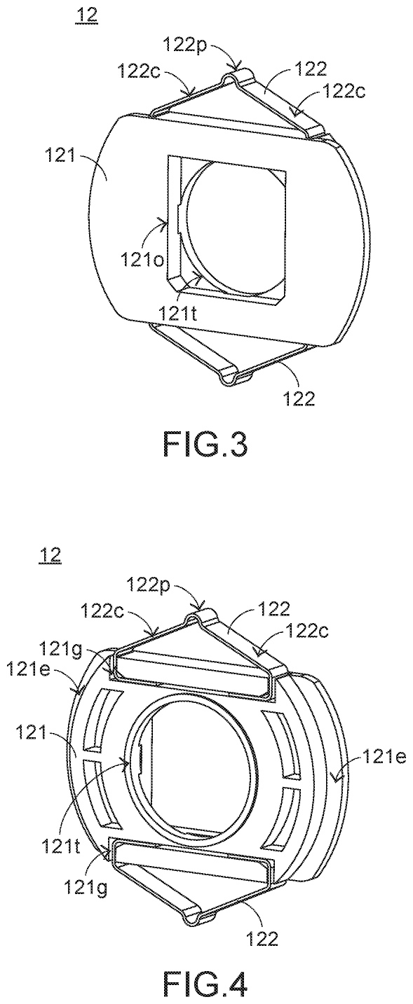

FIG. 3 is a front schematic view of a rotatable structure according to an embodiment of the present invention. As shown in FIG. 3, in addition to the second protruding portion 122p, each of the elastic members 122 further has two connecting portions 122c, and the second protruding portion 122p is connected between the two connecting portions 122c. In some embodiments, the second protruding portion 122p and the two connecting portions 122c are integrally formed, but not limited thereto. The second protruding portion and the two connecting portions can also be assembled with each other to form the elastic member 122. In some embodiments, the elastic member 122 includes a metal material. In some embodiments, the rotatable portion 121 includes a plastic material, such as polyoxymethylene (POM) or any other suitable material.

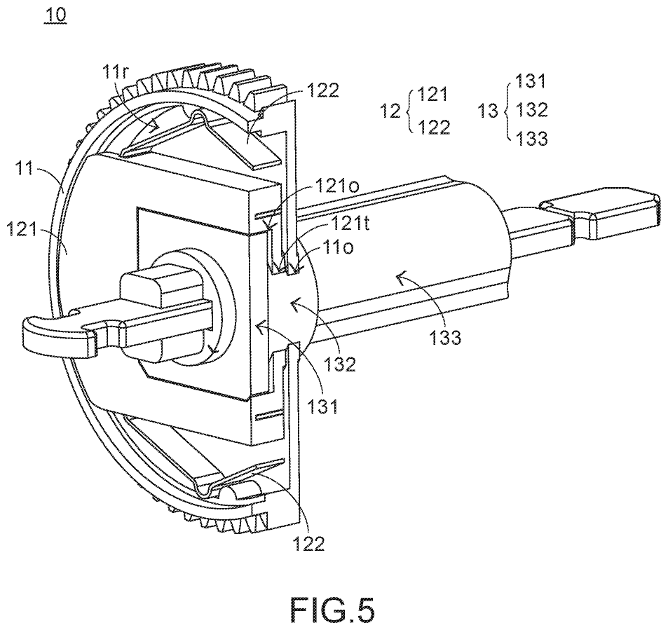

FIG. 4 is a schematic back view of a rotatable structure according to an embodiment of the present invention. As shown in FIG. 4, the rotatable portion 121 has two grooves 121g corresponding to the two elastic members 122, and one end of each of the connecting portions 122c of the elastic member 122 is arranged in the corresponding groove 121g. In some embodiments, as shown in FIGS. 2 and 4, the two grooves 121g are provided in the short axis portion 121s of the rotatable portion 121. In some embodiments, each of the grooves 121g is U-shaped, and the end of each of the connecting portions 122c is L-shaped. In some embodiments, the elastic member 122 is in the form of an open-shaped sheet, but not limited thereto. The elastic member may also be in the form of an open-shaped column, a closed-shaped sheet, or a closed-shaped column.

It is worth noting that, as shown in FIGS. 2 and 4, an assembly method of the transmission mechanism may include following steps: disposing the elastic members 122 into the grooves 121g of the rotatable portion 121, respectively; and disposing the rotatable structure 12 into the first rotating wheel 11. It can be seen that the assembly method of the transmission mechanism/rotatable structure of the present invention is very easy, and the fixing method of the elastic members 122 is simple, and the elastic members 122 can be firmly fixed in the grooves 121g, respectively. On the other hand, there are two elastic members, and the torsion force required for the deformation of the elastic member is moderate, so the service life of each of the elastic members is longer.

In some embodiments, as shown in FIG. 4, the rotatable portion 121 has an edge groove 121e arranged in an edge portion of the rotatable portion 121. As such, when the first rotating wheel 11 shown in FIG. 2 rotates, the two first protruding portions 11p can pass through the edge groove 121e without being blocked by the rotatable portion 121.

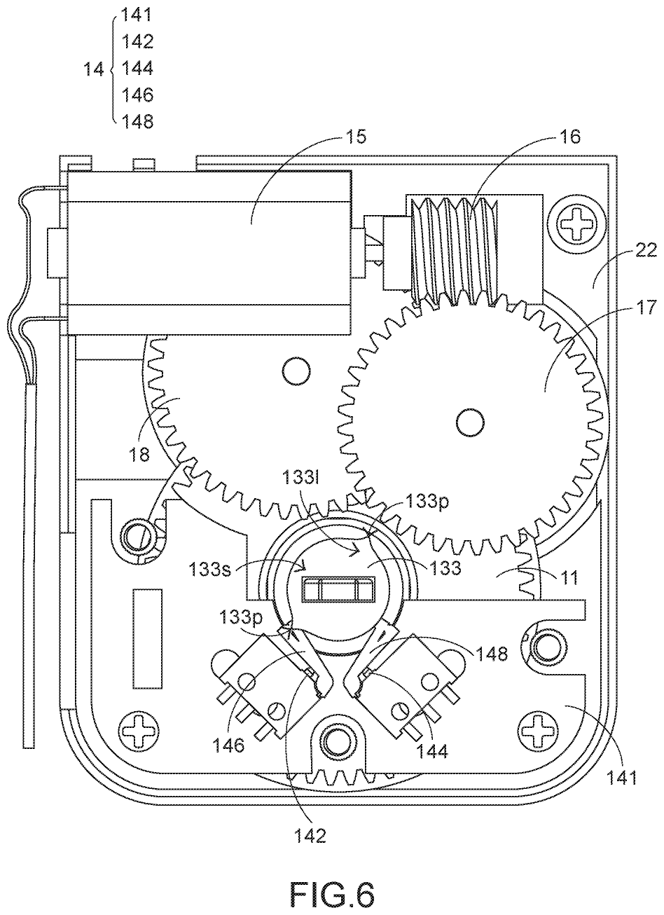

FIG. 5 is a schematic cross-sectional view of a transmission mechanism according to an embodiment of the present invention. As shown in FIG. 5, the transmission mechanism 10 further includes a rotating shaft 13 penetrating the rotatable portion 121 and the first rotating wheel 11. In some embodiments, as shown in FIGS. 2 and 5, except for the rotatable portion 121, the two elastic members 122, and a portion of the rotating shaft 13 are located in the recessed portion 11r, there is no other component located in the recessed portion 11r. It can be seen that the transmission mechanism/rotation structure of the present invention having a small number of components can achieve the purpose of linkage and clutch and take into account safety. Therefore, the transmission mechanism/rotation structure of the present invention is extremely advantageous in terms of cost.

In some embodiments, as shown in FIGS. 3, 4 and 5, the rotatable portion 121 has a first opening 1210 and a second opening 121t through the rotatable portion 121, and the second opening 121t is substantially aligned with the first opening 121o, and a shape of the first to opening 1210 is different from a shape of the second opening 121t. In some embodiments, the first opening 1210 is non-circular (e.g., polygon, such as rectangle, truncated rectangle, square, truncated square, trapezoid, truncated trapezoid, or another suitable non-circular shape), and the second opening 121t is circular.

In some embodiments, as shown in FIG. 5, the first rotating wheel 11 has a third opening 11o through the first rotating wheel 11, and the third opening 11o is adjacent to and substantially aligned with the second opening 121t, and the second opening 121t is located between the first opening 1210 and the third opening 11o, and the shape of the second opening 121t is substantially same as a shape of the third opening 11o. In some embodiments, both of the second opening 121t and the third opening 11o are circular. Although the second opening 121t and the third opening llo can both be circular, a cross-sectional area of the second opening 121t and a cross-sectional area of the third opening 11o can be the same or slightly different from each other.

In some embodiments, as shown in FIG. 5, the rotating shaft 13 has a first portion 131 and a second portion 132 connected to each other, and the first portion 131 is arranged in the first opening 1210 of the rotatable portion 121, and the second portion 132 is arranged in the second opening 121t of the rotatable portion 121 and the third opening 110 of the first rotating wheel 11. In some embodiments, a cross-section of the first portion 131 is non-circular (e.g., polygon, such as rectangle, truncated rectangle, square, truncated square, trapezoid, truncated trapezoid, or another suitable non-circular shape), and a cross section of the second portion 132 is circular.

In some embodiments, as shown in FIG. 5, the rotating shaft 13 further has a third portion 133 connected to the second portion 132, and the second portion 132 is connected between the first portion 131 and the third portion 133.

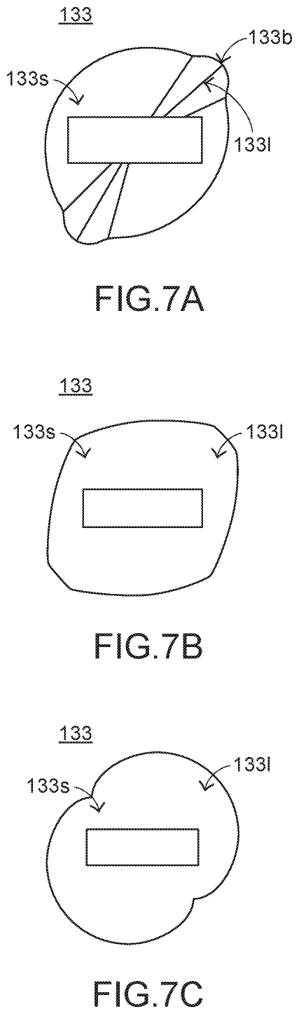

FIG. 6 is a schematic top view of a transmission mechanism of an electromechanical lock according to an embodiment of the present invention. In some embodiments, as shown in FIGS. 5 and 6, a portion (i.e., the third portion 133) of the rotating shaft 13 is away from the rotatable portion 121 and protrudes outside the first rotating wheel 11. In some embodiments, as shown in FIG. 6, the transmission mechanism further includes a circuit board 14 close to the third portion 133 of the rotating shaft 13. The circuit board 14 includes a substrate 141, an unlock switch 142 and a lock switch 144. The unlock switch 142 and the lock switch 144 are disposed on the substrate 141. In some embodiments, as shown in FIG. 6, the third portion 133 of the rotating shaft 13 has a long axis portion 133l and a short axis portion 133s, and the long axis portion 133l of the third portion 133 has two ends, and each of the ends has a sharp point 133p to trigger the unlock switch 142 or the lock switch 144 to unlock or lock. Specifically, when the rotating shaft 13 is rotated, the end of the long axis portion 133l of the third portion 133 of the rotating shaft 13 directly or indirectly presses the unlock switch 142 to unlock, or the end of the long axis portion 133l of the third portion 133 of the rotating shaft 13 directly or indirectly presses the lock switch 144 to lock.

In some embodiments, as shown in FIG. 6, the circuit board 14 further includes a first swing arm 146 and a second swing arm 148. The first swing arm 146 corresponds to the unlock switch 142 and is arranged between the third portion 133 of the rotating shaft 13 and the unlock switch 142. The second swing arm 148 corresponds to the lock switch 144 and is arranged between the third portion 133 of the rotating shaft 13 and the lock switch 144. If the sharp point 133p exerts a lateral force to directly contact and press the unlock switch 142/lock switch 144 when the third portion 133 of the rotatable portion 13 is rotated, it may shorten the life of the unlock switch 142/lock switch 144. However, the unlock switch 142/lock switch 144 can be pressed by the first swinging arm 146/the second swinging arm 148, and thus the lateral force damaging the unlock switch 142/lock switch 144 can be avoided.

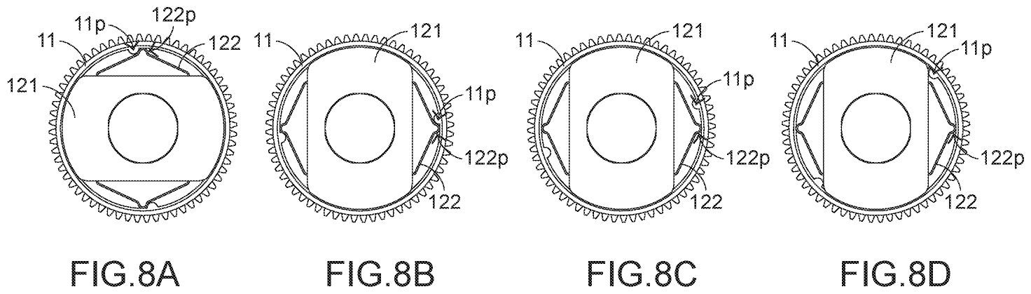

It should also be noted that the shape of the third portion 133 of the rotating shaft 13 is not limited to the embodiment shown in FIG. 6. FIGS. 7A, 7B, and 7C are schematic top views of a third portion of a rotating shaft according to some embodiments of the present invention. The difference between FIG. 7A and FIG. 6 is that each of the ends of the long axis portion 133l of FIG. 7 has a convex point (or bump point) 133b whose radius of curvature is larger than that of the sharp point 133p of FIG. 6. The difference between FIGS. 7B and 7C and FIG. 6 is that the third portion 133 of FIG. 7B is diamond-shaped, and the third portion 133 of FIG. 7C is 8-shaped.

In some embodiments, as shown in FIGS. 2 and 6, the transmission mechanism further includes an electric actuator 15, a turbine 16 and a second rotating wheel 17. The turbine 16 is connected to the electric actuator 15. The second rotating wheel 17 is connected between the turbine 16 and the first rotating wheel 11. The turbine 16 and the second rotating wheel 17 are configured to transmit torque output by the electric actuator 15 to the first rotating wheel 11. In some embodiments, the transmission mechanism further includes a third rotating wheel 18 connected between the second rotating wheel 17 and the first rotating wheel 11. The turbine 16, the second rotating wheel 17 and the third rotating wheel 18 are configured to transmit the torque output by the electric actuator 15 to the first rotating wheel 11.

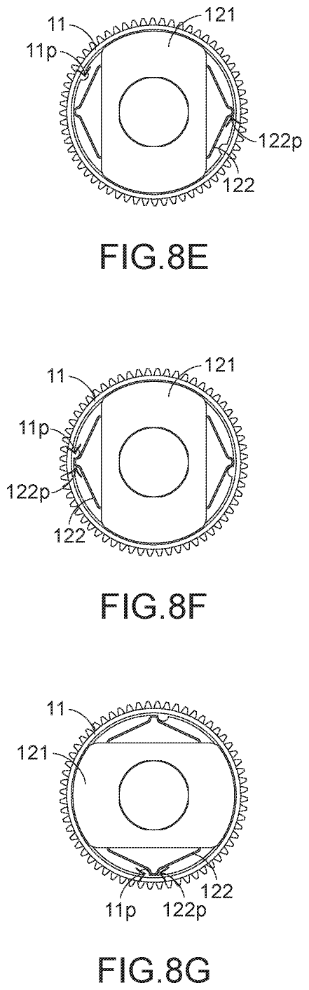

Action mechanisms of the transmission mechanism of the electromechanical lock of the present invention will be described below. FIGS. 8A, 8B, 8C, 8D, 8E, 8F and 8G are schematic diagrams of a general mechanism of a transmission mechanism according to an embodiment of the present invention. In some embodiments, as shown in FIGS. 8A and 8B, a door latch (not shown) is locked (or unlocked) through the transmission mechanism. Specifically, the turbine 16, the second rotating wheel 17, and the third rotating wheel 18 shown in FIGS. 2 and 6 transmit the torque output by the electric actuator 15 to the first rotating wheel 11, and the first rotating wheel 11 rotates in a clockwise direction. Next, the first rotating wheel 11 drives the rotatable portion 121 and the two elastic members 122 of the rotatable structure to rotate when one of the two first protruding portions 11p interferes with the second protruding portion 122p, so that the rotatable portion 121 is rotated 90 degrees in the clockwise direction to drive the door latch (not shown) to a lock position (or an unlock position).

In some embodiments, as shown in FIGS. 8B, 8C, 8D, 8E, 8F, and 8G, the door latch is unlocked (or locked) through the transmission mechanism. Specifically, as shown in FIGS. 8B, 8C, 8D, and 8E, the turbine 16, the second rotating wheel 17, and the third rotating wheel 18 shown in FIGS. 2 and 6 transmit the torque output by the electric actuator 15 to the first rotating wheel 11, and the first rotating wheel 11 rotates in a counterclockwise direction. Since each of the first protruding portions 11p does not interfere with each of the second protruding portions 122p at this time, the rotatable portion 121 and the two elastic members 122 of the rotatable structure do not rotate. Next, as shown in FIGS. 8E, 8F and 8G, the first rotating wheel 11 continues to rotate in the counterclockwise direction, and the first rotating wheel 11 drives the rotatable portion 121 and the two elastic members 122 of the rotatable structure to rotate when one of the two first protruding portions 11p interferes with the second protruding portion 122p, so that the rotatable portion 121 rotates 90 degrees in the counterclockwise direction to drive the door latch to an unlock position (or a lock position).

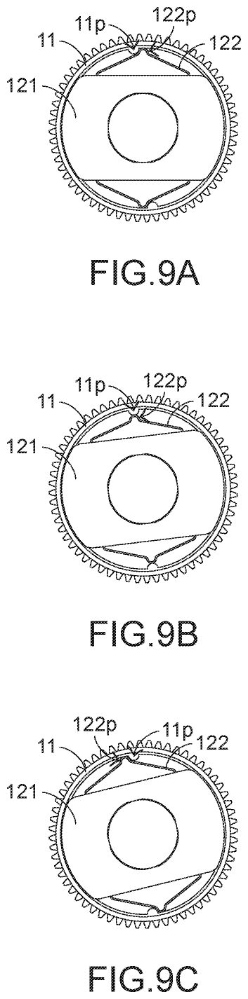

FIGS. 9A, 9B, and 9C are schematic diagrams of a safety mechanism of a transmission mechanism according to an embodiment of the present invention. As shown in FIGS. 9A, 9B and 9C, when the lock body fails, reset in case of sudden power failure, or when the locked/unlocked position is incorrect, that is, when the first rotating wheel 11 cannot rotate, the rotating shaft 13 as shown in FIG. 5 can be rotated by applying appropriate torsion force manually (e.g., using a key or a rotary knob) to drive the rotatable portion 121 of the rotatable structure to rotate. During the rotation of the rotatable portion 121, the two elastic members 122 are elastically deformed, and the second protruding portion 122p is moved from a side of one of the two first protruding portions 11p to another side of the one of the two first protruding portions 122p, and then the rotatable portion 121 continuously rotates to a corresponding position to drive the door latch to the unlock position (or the lock position).

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not used to limit the scope of claims of the present invention.

What is claimed is:

1. A transmission mechanism of an electromechanical lock, comprising:
a first rotating wheel having a recessed portion and two first protruding portions, wherein the recessed portion is arranged in a center of the first rotating wheel, and the two first protruding portions are separated from each other and protrude from a side surface of the recessed portion; and
a rotatable structure arranged in the recessed portion, and the rotatable structure comprising:
a rotatable portion rotatably arranged in the recessed portion; and
two elastic members separated from each other and connected to the rotatable portion, wherein each of the elastic members has a second protruding portion close to the side surface of the recessed portion and is configured to interfere with each of the first protruding portions.

2. The transmission mechanism of the electromechanical lock of claim 1, wherein the rotatable portion has two grooves corresponding to the two elastic members, respectively, and each of the elastic members further has two connecting portions, and the second protruding portion is connected between the two connecting portions, and one end of each of the connecting portions is arranged in the corresponding groove.

3. The transmission mechanism of the electromechanical lock of claim 2, wherein the rotatable portion has a long axis portion and a short axis portion, and the long axis portion is close to the side surface of the recessed portion, and the two grooves are arranged in the short axis portion.

4. The transmission mechanism of the electromechanical lock of claim 2, wherein each of the grooves is U-shaped, and the end of each of the connecting portions is L-shaped.

5. The transmission mechanism of the electromechanical lock of claim 1, wherein the rotatable portion has an edge groove arranged in an edge of the rotatable portion, and when the first rotating wheel rotates, the two first protruding portions are able to pass through the edge groove.

6. The transmission mechanism of the electromechanical lock of claim 1,
wherein when the first rotating wheel rotates and one of the two first protruding portions interferes with the second protruding portion, the first rotating wheel drives the rotatable structure to rotate; and when the first rotating wheel rotates and each of the first protruding portions does not interfere with each of the second protruding portions, the rotatable structure does not rotate.

7. The transmission mechanism of the electromechanical lock of claim 1, further comprising:
a rotating shaft penetrating the rotatable portion and the first rotating wheel.

8. The transmission mechanism of the electromechanical lock of claim 7, wherein except for the rotatable portion, the two elastic members and a portion of the rotating shaft are located in the recessed portion, there is no other component located in the recessed portion.

9. The transmission mechanism of the electromechanical lock of claim 7, wherein when the first rotating wheel cannot rotate and the rotating shaft is rotated, the rotating shaft drives the rotatable structure to rotate to unlock.

10. The transmission mechanism of the electromechanical lock of claim 9, wherein when the rotating shaft is rotated, the second protruding portion is moved from a side of one of the two first protruding portions to another side of the one of the two first protruding portions to unlock.

11. The transmission mechanism of the electromechanical lock of claim 7, wherein a portion of the rotating shaft is away from the rotatable portion and protrudes out of the first rotating wheel, and the portion of the rotating shaft has a long axis portion and a short shaft portion, and the transmission mechanism further comprises:
a circuit board close to the portion of the rotating shaft, and the circuit board comprising:
a substrate; and
an unlock switch and a lock switch arranged over the substrate, wherein when the rotating shaft is rotated, one end of the long axis portion of the portion of the rotating shaft directly or indirectly presses the unlock switch to unlock, or one end of the long axis portion of the portion of the rotating shaft directly or indirectly presses the lock switch to lock.

12. The transmission mechanism of the electromechanical lock of claim 11, wherein the circuit board further comprises:
a first swing arm corresponding to the unlock switch and arranged between the portion of the rotating shaft and the unlock switch; and
a second swing arm corresponding to the lock switch and arranged between the portion of the rotating shaft and the lock switch.

13. The transmission mechanism of the electromechanical lock of claim 1,
wherein the rotatable portion has a first opening and a second opening through the rotatable portion, and the second opening is substantially aligned with the first opening, and a shape of the first opening is different from a shape of the second opening, and the first rotating wheel has a third opening through the first rotating wheel and adjacent to and substantially aligned with the second opening, and the shape of the second opening is substantially same as a shape of the third opening, and the transmission mechanism further comprises:
a rotating shaft having a first portion and a second portion connected to each other, wherein the first portion is arranged in the first opening of the rotatable portion, and the second portion is arranged in the second opening of the rotatable portion and the third opening of the first rotating wheel.

14. The transmission mechanism of the electromechanical lock of claim 13, wherein the first opening is non-circular, and the second opening and the third opening are circular.

15. The transmission mechanism of the electromechanical lock of claim 13, wherein the rotating shaft further has a third portion connected to the second portion, and the second portion is connected between the first portion and the third portion, and the third portion has a long axis portion and a short axis portion, and the long axis portion of the third portion has two ends, and each of the ends has a convex point or a sharp point.

16. The transmission mechanism of the electromechanical lock of claim 1, further comprising:
an electric actuator;
a turbine connected to the electric actuator; and
a second rotating wheel connected between the turbine and the first rotating wheel, wherein the turbine and the second rotating wheel are configured to transmit torque output by the electric actuator to the first rotating wheel.

17. The transmission mechanism of the electromechanical lock of claim 16, further comprising:
a third rotating wheel connected between the second rotating wheel and the first rotating wheel, and the turbine, the second rotating wheel and the third rotating wheel are configured to transmit the torque output by the electric actuator to the first rotating wheel.
